(19) United States
(12) Patent Application Publication
(10) Pub. No.: US 2006/0031120 A1
(43) Pub. Date: Feb. 9, 2006

(54) System and method for enrolling new members in a loyalty or club program

(76) Inventors: David A. Roehr, Lincoln, NE (US); Thomas Boatman, Lincoln, NE (US)

Correspondence Address: BACHMAN & LAPOINTE, P.C., 900 CHAPEL STREET, SUITE 1201, NEW HAVEN, CT, 06510, US

(21) Appl. No.: 11/200,339

(22) Filed: Aug. 9, 2005

Related U.S. Application Data
(60) Provisional application No. 60/600,166, filed on Aug. 9, 2004.

(51) Int. Cl. G06Q 30/00

(52) U.S. Cl. 705/14

(57) ABSTRACT

A method for enrolling a prospective member into a loyalty or club program comprises the steps of obtaining information from the prospective member, transmitting the obtained information to an information database used to determine membership, determining whether membership in the loyalty or club program should be extended to the prospective member, maintaining an activity tracking database, and forwarding results of the membership determining step to the activity tracking database.

### CROSS-REFERENCE TO RELATED APPLICATION

The instant application claims the benefit of U.S. provisional patent application 60/600,166, filed Aug. 9, 2004, entitled SYSTEM AND METHOD FOR ENROLLING NEW MEMBERS IN A LOYALTY OR CLUB PROGRAM.

### BACKGROUND OF THE INVENTION

(1) Field of the Invention

The present invention relates to a system and a method for enrolling new members into loyalty or club programs affiliated with organizations which offer goods and services to the consumers.

(2) Prior Art

For many years, merchandisers have attempted to increase their market share by providing incentives to potential customers. Among these incentives have been loyalty or club programs designed to reward frequent customers. Often, merchandisers have linked these reward programs to credit cards so that customers can increase their eligibility for rewards.

Despite the existence of such loyalty programs, there remains a need for a system and a method which enables quick enrollment of prospective members.

### SUMMARY OF THE INVENTION

Accordingly, it is an object of the present invention to provide a method for enrolling prospective members in a loyalty or club program operated by a merchandiser.

The foregoing object is attained by the method of the present invention.

In accordance with the present invention, a method for enrolling and increasing the membership of a merchandiser's club or loyalty program is provided. The method broadly comprises the steps of obtaining information from the prospective member, transmitting the obtained information to an information database used to determine membership, determining whether membership in the loyalty or club program should be extended to the prospective member, maintaining an activity tracking database, and forwarding results of the membership determining step to the activity tracking database.

Other details of the system and method for enrolling new members in a loyalty or club program of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a flow chart illustrating a method and system for enrolling new members in a club or loyalty program in accordance with the present invention;

FIG. 2 is a flow chart illustrating a business rules filter program for use in the method and system of FIG. 1;

FIG. 3 is a flow chart illustrating compilation of an activity tracking database for use in the method and system of the present invention; and

FIG. 4 is a flow chart that illustrates the process for creating points and redeeming points for club members.

### DETAILED DESCRIPTION OF THE PREFERRED EMBODIMENT(S)

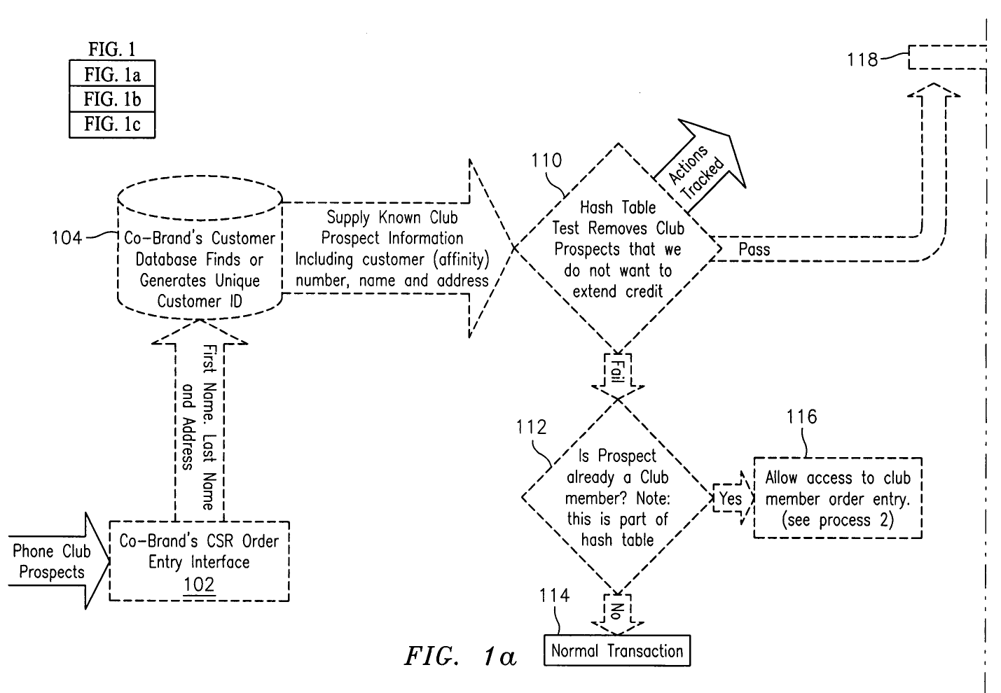

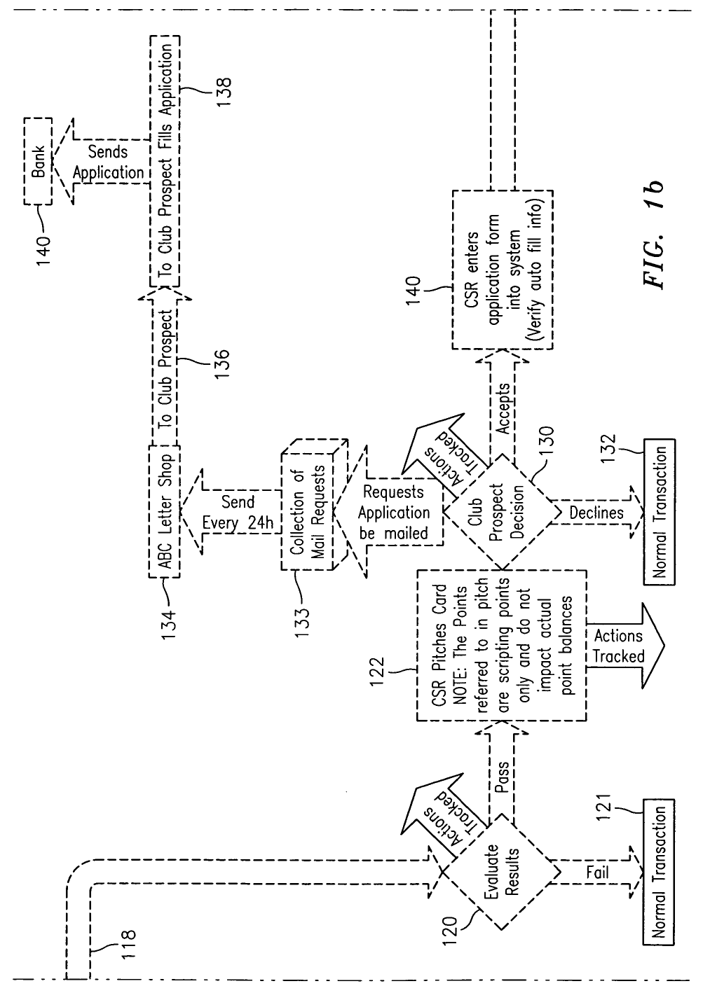

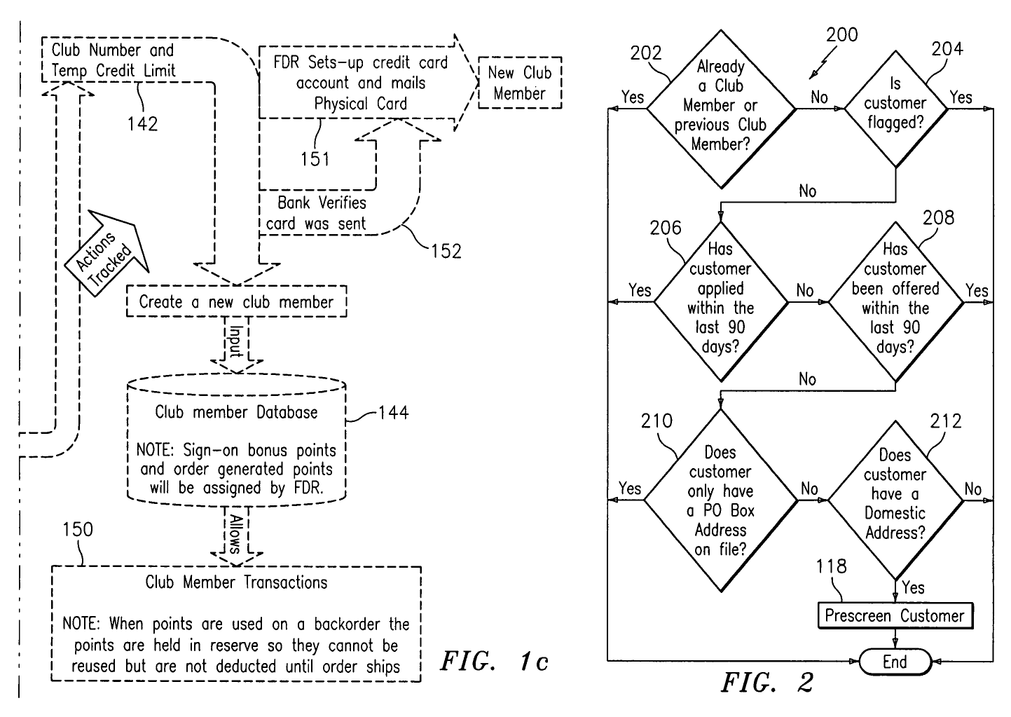

Referring now to FIG. 1, a flow chart is illustrated which shows a system and method for enrolling prospective members into a loyalty or club program operated by a merchandiser. As shown therein, a prospective member makes an initial contact with the merchandiser in box 102. As used herein, the term “merchandiser” may refer to any organization that provides goods and/or services to others. For example, the “merchandiser” could be a retail shopping organization, a wholesale shopping organization, a hotel chain, an airline, a service organization, etc. The contact made by the prospective member may be made via any suitable means known in the art. For example, the contact could be a telephone contact in which the customer is using a telephone to place an order, an Internet contact via a website operated by the merchandiser through which the customer is placing an order, or a personal contact during a sales transaction at a point-of-sale terminal. During the entry or initial contact, information about the prospective member, such as his/her first name, his/her last name, and his/her address, may be recorded by the merchandiser.

As shown in FIG. 1, the information about the prospective member may be transmitted to an information database 104 operated by the merchandiser. The information database 104 may be stored on a central processing unit or on storage media associated with a central processing unit. The central processing unit may comprise any suitable central processing unit known in the art. Similarly, the storage media may be any suitable storage media known in the art including tapes, diskettes, CD-roms, etc.

The central processing unit preferably uses the contact information about the prospective member to generate a unique ID (identification) for the prospective member. The central processing unit then supplies the information known about the prospective member to a business rules filter program, as shown in step 110, which is used to determine whether membership in the loyalty or club program should be extended to the prospective member. The business rules filter program may be a program run by the central processing unit or some other processing unit maintained by the merchandiser which is in communication with the information database 104. The business rules filter program may be specifically designed to remove prospective members to which membership and/or credit is not to be extended. Decisions on whether to extend credit to a prospective member may be made using any suitable criteria known in the art. Each merchandiser may have a unique set of criteria or a common set of criteria may be used by all merchandisers. The business rules filter program also searches the database 104 to see whether the prospective member is already a member of the loyalty or club program. This is shown in step 112.

If the business rules filter program leads to a decision to deny membership and/or a credit card to the prospective member, the business rules filter program then determines if the prospective member is already a member of the loyalty or club program. If the answer to this membership inquiry is no, the merchandiser may allow the prospective member to participate only in a normal business transaction as shown in step 114. If the business rules filter program determines that the prospective member is already a member of the loyalty or club program, then the member may be allowed access to available club member purchase programs for placing orders as shown in step 116.

FIG. 2 illustrates a business rules filter program 200 which may be used in the method and system of the present invention. As shown in this figure, the first step 202 questions whether the prospective member is already a club or program member or a previous club or program member. This may be done by checking a club master file maintained by the merchandiser. If desired, the club master file may be stored in the information database 104. This part of the program may also check to be sure that any member which matches to the same name/address is not already in the club master file. If the answer to the question in step 202 is yes, the prospective membership fails, the business rules filter program ends, and the prospective member is allowed to complete a normal business transaction as shown by step 116.

If the answer to the question in step 202 is no, the program proceeds to step 204. Here the program inquires whether the prospective member has been flagged. This means that the program may check to see if the prospective member is in one of the following categories: criminal; don't offer; anti-customer; hold next order; bad address; bad check; previous bad check; and credit card charge back. If the prospective member has been flagged, then a fail signal is generated and sent to the merchandiser such as by a signal sent to a POS terminal or a signal sent to a person talking to the prospective member. The business rules filter program then ends and the prospective member is allowed to complete a purchase transaction as shown in step 114. If the prospective member has not been flagged, the program proceeds to step 206.

In step 206, the program questions whether the prospective member has applied for membership within a set determined time period, such as the last 90 days. This may be done by the program checking an application file maintained by the merchandiser. If the prospective member has applied within the set determined time period, the program sends a fail signal, the business rules filter program ends, and the prospective member completes the sales transaction as shown in step 114. If the prospective member has not applied within the set determined time period, the program proceeds to step 208 where it is determined whether an offer has been extended to the prospective member within the set determined time period. This may be done by checking a prescreened customer file maintained by the merchandiser. If the prospective member has been made an offer within the set determined time period, the program sends a fail signal to the merchandiser, the business rules filter program ends, and the prospective member is sent to step 114 to complete the sales transaction. If the prospective member has not been made an offer within the set determined time period, the program proceeds to step 210.

In step 210, the program may be used to determine whether the prospective member only has a post office box address on file. This may be done by checking a customer file maintained by the merchandiser. If the answer to this inquiry is yes, the program may send a fail signal to the merchandiser, the business rules filter program may end, and the prospective member may complete the sales transaction as shown in step 114. If the answer is no, the program proceeds to step 212. Alternatively, step 210 may be omitted in situations where post office box addresses are not excluded from the process.

In step 212, the program determines whether the prospective customer has a domestic address. This also may be done by checking the customer file maintained by the merchandiser. If the answer to the query is no, then the program may transmit a fail signal to the merchandiser, the business rules filter program may end, and the prospective member may complete the sales transaction as shown in step 114. If the answer to the query is yes, the program may proceed to transmit information about the prospective member to step 118 for prospective member prescreening.

As shown in FIG. 1, the personal information about the prospective member is electronically forwarded to a credit facilitator as shown in step 118. The information may be transmitted by a high speed line. The credit facilitator electronically sets up an initial file for each prospective member and electronically transmits the personal information to one or more credit bureaus. The credit bureau(s) receive the personal information and electronically check their records to determine a creditworthiness score for each prospective member being considered. The creditworthiness score may be compared to a minimum threshold level and a signal representative of the creditworthiness of each prospective member is transmitted to the credit facilitator. The credit facilitator then transmits an approval or a non-approval signal to the merchandiser as shown in step 120. If the creditworthiness score is below a threshold value, no credit card offer is to be made to the prospective member. This is represented by the fail arrow in FIG. 1. The prospective member is then allowed to complete his/her transaction in a normal manner as shown in step 121. If the creditworthiness score is above the threshold, a pass signal is generated and the method proceeds to step 122. The prospective member credit prescreening may be accomplished by the credit facilitator using any suitable program which identifies whether the prospective member is sufficiently creditworthy to be offered a credit card which is linked to the club or loyalty program and which entitles the prospective member to member discounts and/or member rewards.

In step 122, a pitch is made to the prospective member. The pitch may be done by telephone, in person, over the Internet, or by mail. The pitch is an attempt to get the prospective member to sign up for a credit card affiliated with the club or loyalty program. As part of the pitch, incentives may be provided to get the prospective member to accept the credit card.

At this point, as shown in step 130, the prospective has three possible decisions—(1) the prospective member may decline the opportunity to obtain the credit card; (2) the prospective member may accept the opportunity to obtain the credit card; and (3) the prospective member may ask that a credit card application be mailed. If the prospective member elects option (1), the prospective member is then allowed to purchase goods as part of a normal business transaction as shown in step 132. If the prospective member elects option (3), his/her request is collected through the day with similar requests as shown in step 133. Then the collected requests are transmitted to an organization 134, such as a print shop, which generates a letter and a mailing which may include a credit card application to each prospective customer in the pool as shown in step 136. The letter and mailing sequence may occur once every 24 hours. If the prospective customer/credit card applicant returns the application as shown in step 138, the application is sent to a financial institution such as a bank 140 where the application is processed to initiate the issuance of a credit card affiliated with the club or loyalty program to the prospective member.

If the prospective member elects option (2), his/her credit card application form is immediately entered into the merchandiser's system as shown in step 140. The credit card application is then sent to the credit facilitator for further credit checks, if needed, and for creation of a club or loyalty program identification number and a credit limit as shown in step 142. The club or loyalty program identification number and the credit limit information is transmitted to the club member database 144 and leads to the creation of a new club membership, as shown in step 146, which is inputted into the club member database 144. The club member database 144 may also be a central processing unit that is programmed to track the activities of the club or loyalty program. For example, the club member database 144 may be pre-programmed to provide a new club member with sign-on bonus points and order generated points. Once the new club membership has been created, the new club member may be allowed to perform club member transactions as shown in step 150.

At the same time that the credit facilitator issues the club number and credit limit, information about the new membership and/or the new club member may be sent to a bank or other financial institution for issuance of a credit card, as shown in step 151, for the new club or loyalty program member. As shown in step 152, the financial information after a time delay, i.e. two day time delay, verifies that the credit card has been sent to the new club member has been sent as shown in step 152.

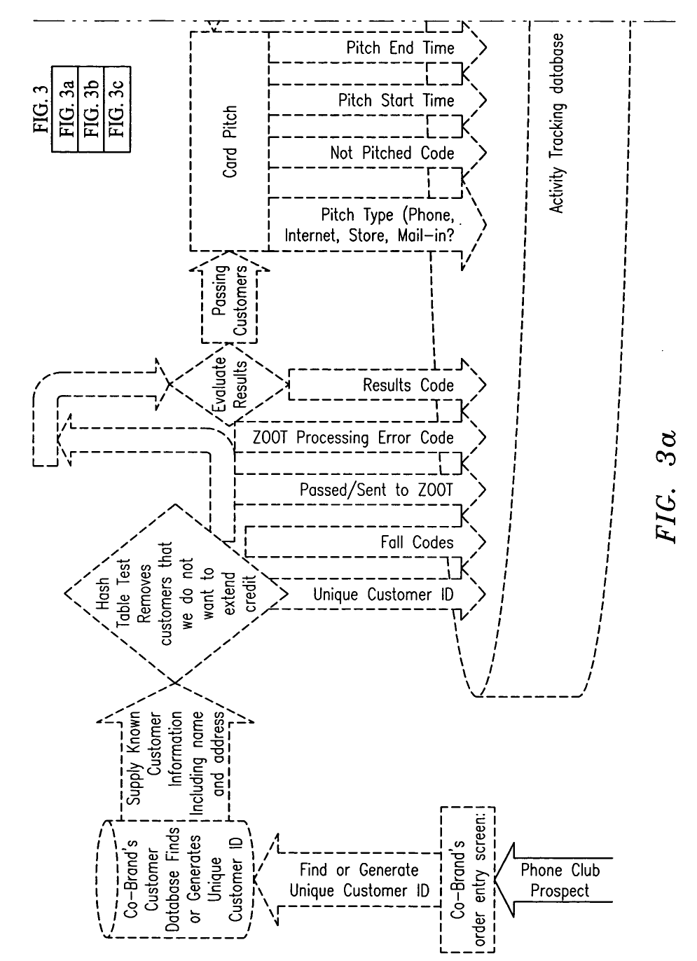

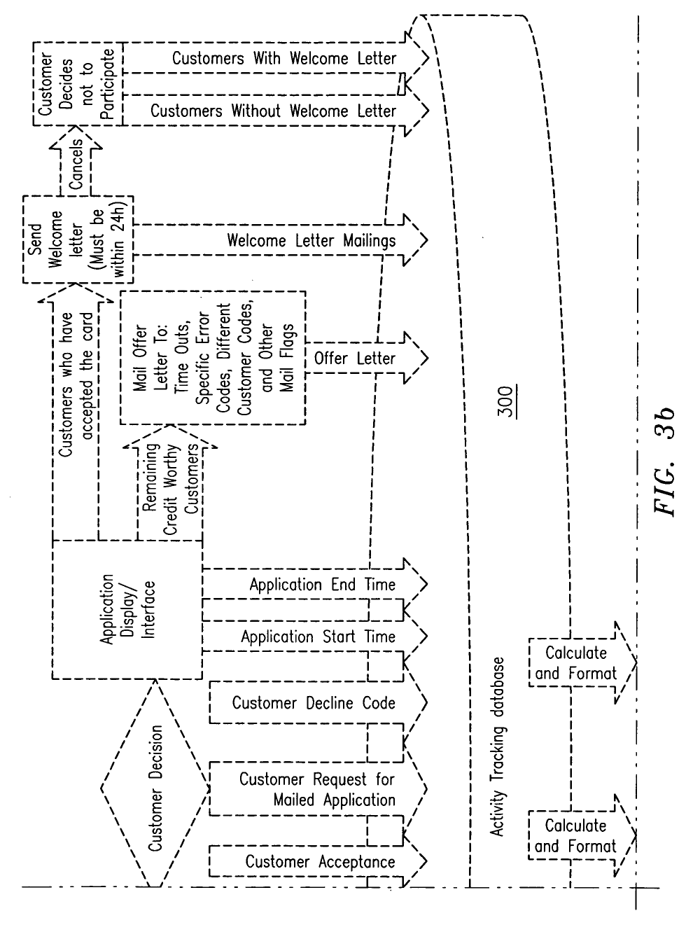

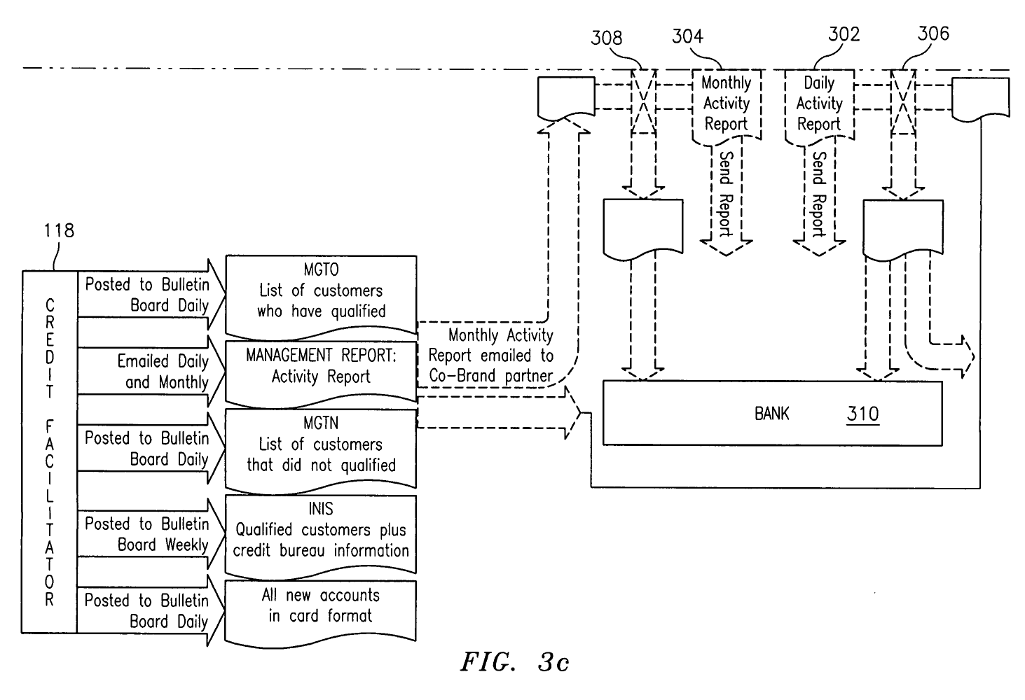

During the processing of each prospective member, information about the processing may be transmitted to an activity tracking database 300. As shown in FIG. 3, information such as the unique customer number given to the prospective member, the fail/pass results of the business rules filter program, the credit bureau processing code and results, the type of pitch (phone, Internet, store, mail-in, etc.) made to the prospective customer, a not pitched code, pitch start and stop times, customer acceptance of the credit card pitch, customer request for a mail application, customer decline of the credit card, application start time and end time, offer letter, welcome letter mailings, customers with welcome letter, and/or customer without welcome letter may be inputted into the database 300. The compilation of this data helps the merchandiser determine such matters as whether the prospective member has been approached before, whether the prospective member has declined membership, whether the prospective member has accepted membership, amongst other things. For example, the data in the database 300 provides the merchandiser with information about the success of the pitches made to prospective customers. This information is extremely useful in helping a merchandiser improve its success rate on enrolling new members into its club or loyalty program.

Desired information may be compiled on a daily (step 302) and/or a monthly (step 304) basis. The compiled information may then be transmitted in report form to a financial institution 310 such as the bank or other financial institution issuing the credit cards.

The daily and monthly activity reports may be compared as shown in steps 306 and 308 with daily and monthly activity reports generated by the institution doing the credit checks on prospective members. These comparisons may then be sent to the financial institution (step 310) and if desired the merchandiser. These comparison reports enable the financial institution, as well as the merchandiser, to determine whether all prospective members were processed by the institution doing the credit checks. If desired, the comparison reports may contain explanations for any discrepancies in the processing of the prospective members.

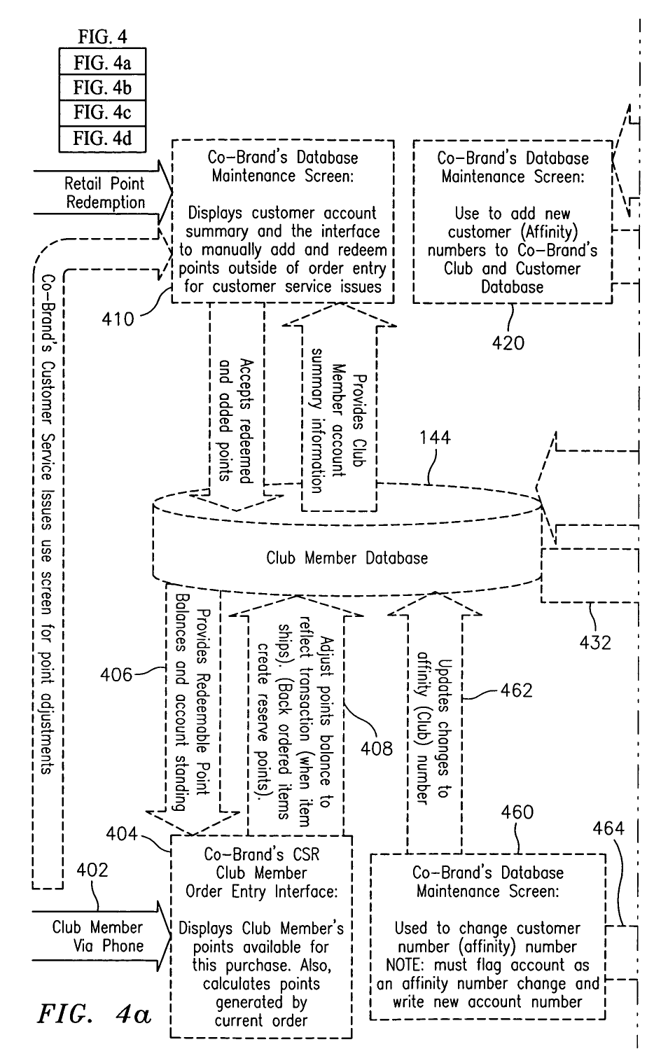

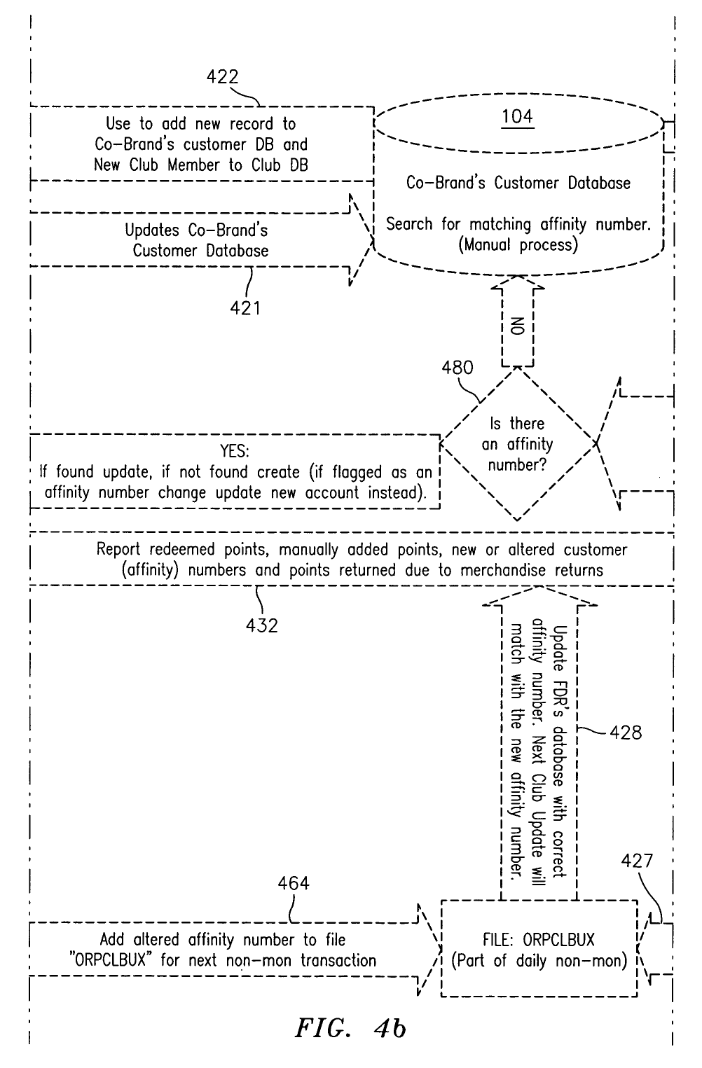

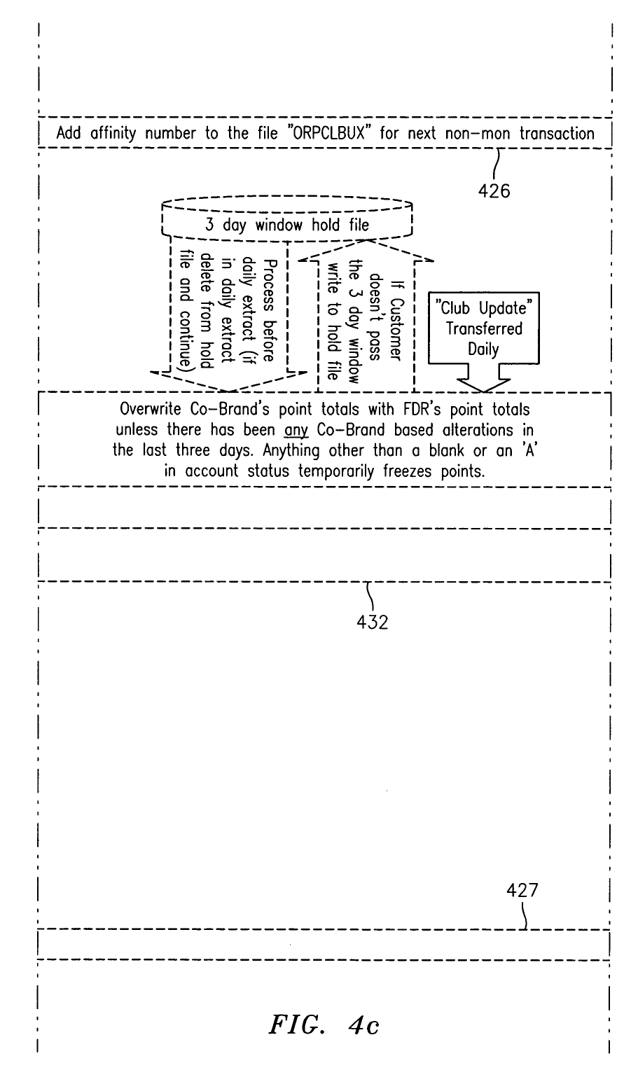

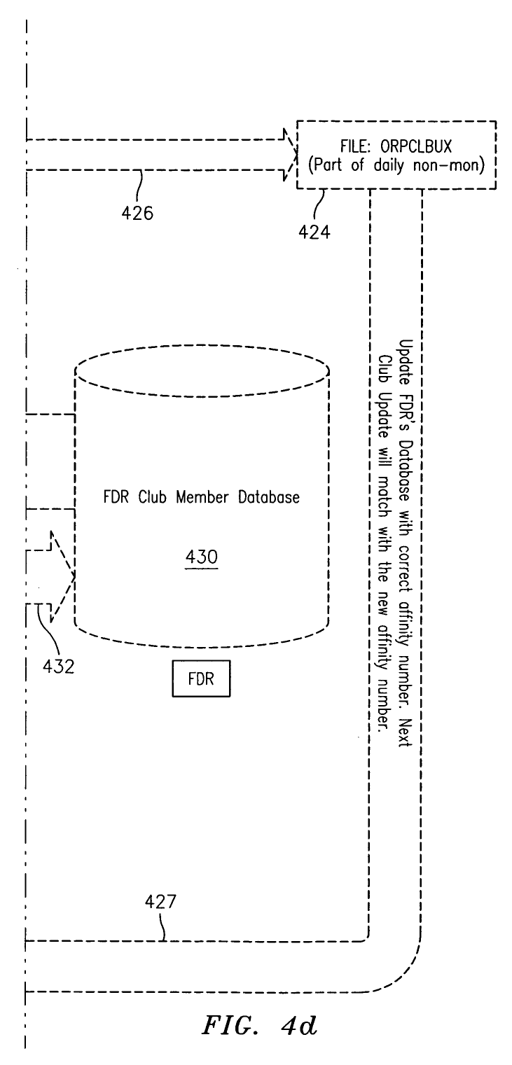

Referring now to FIG. 4, there is shown a flow chart that illustrates the process for creating points and redeeming points for club members. As shown therein, the process for creating and redeeming points revolves around the club member database 144. As shown therein, in step 402, a club member may purchase goods/services via telephone. This order is entered into the merchandiser's entry interface 404 which displays the club member's points available for this purchase. Additionally, the entry interface may have displayed on it a determination of the number of points in the club or loyalty program generated by this order. The information about the redeemable points available to the club member and the standing of his/her account is passed from the database 144 to the entry interface 404 as shown in step 406. Once the transaction has been completed, information about the transaction is transmitted to the database 144 as shown in step 408, which information may be used to adjust point balances for the club member when the ordered item(s) are shipped and/or create a point reserve if the ordered item(s) are back ordered.

If a club member wishes to redeem points, he may contact the merchandiser and be placed in contact with a database maintenance screen 410. The contact may be made via the Internet and/or the merchandiser's website. The screen 410 displays the club member account summary. If points need to be added to the account, this also may take place at the screen 410. The club member account information is provided to the screen 410 by the database 144. Information about redeemed points and/or added points is passed from the screen 410 to the database 144.

The database 144 may be updated periodically. This may be done by using a database maintenance screen 420 to input new customer (member) numbers to the customer database 104 as shown by arrow 421. When this information is received by the database 104, a search may be made for matching customer numbers. The maintenance screen 420 may be used to add new records to the customer database and new club members to the club database as shown by arrow 422. Alternatively, a club member may be allowed to redeem and/or add points at a point-of-sale terminal, by telephone during a telephone transaction, by mail during a mail transaction, or in any other manner deemed appropriate by the merchandiser.

The database 104 transmits all new customer numbers to a file 424 as shown by arrow 426. This information is then used to update an FDR Club Member Database 430 as shown by arrows 427 and 428.

The FDR Club Member Database 430 also receives from the club member database 144 maintained by the merchandiser information about redeemed points, manually added points, new or altered customer numbers, and points returned due to merchandise returns as shown by arrow 432.

The FDR Club Member Database may be used to issue an instruction to overwrite the point totals in the club member database 144 with the FDR database point totals unless there has been any merchandiser based alterations in the last few days. The database 430 may also issue an instruction to temporarily freeze points in an account. This may be done if a customer does not pass a three day window for some reason as shown in FIG. 4.

As can be seen in FIG. 4, a search is conducted for a customer number in step 450. The search may be conducted in any suitable manner. If the customer number is found, the records in the club member database 144 for that customer number are updated. If the affinity number is not found, a new account is created in the customer database 144 instead. In this way, the club member database 144 is updated to have current information.

If desired, the customer number may be changed using the maintenance screen 460. The changed customer number can be presented to the club member database as shown by arrow 462. It may also be provided to the FDR database 430 as shown by arrow 464.

As can be seen from the foregoing discussion, a system and a method for enrolling new members into a club or loyalty program has been developed. The system and method are advantageous in that it allows enrollment to take place quickly and in a way pleasing to the new member. It also allows a merchandiser to check the creditworthiness of prospective members without the prospective member being aware of same and thus, allowing normal business transactions to occur if the prospective member does not meet a creditworthiness test. The system and method of the present invention also allow the merchandiser, as well as other institutions, to maintain an up-to-date membership database which accurately reflects the status of a member's account.

It is apparent that there has been provided in accordance with the present invention, a system and method for enrolling new members in a loyalty or club program which fully satisfies the objects, means, and advantages set forth hereinbefore. While the present invention has been described in the context of specific embodiments thereof, other alternatives, variations, and modifications will become apparent to those skilled in the art having read the foregoing description. Accordingly, it is intended to embrace those alternatives, modifications, and variations as fall within the broad scope of the appended claims.

What is claimed is:

1. A method for enrolling a prospective member into a loyalty or club program comprising the steps of:
obtaining information from the prospective member;
transmitting said obtained information to an information database used to determine membership;
determining whether membership in said loyalty or club program should be extended to said prospective member;
maintaining an activity tracking database; and
forwarding results of the membership determining step to said activity tracking database.

2. The method according to claim 1, wherein said information obtaining step includes obtaining information about the name of the prospective member and the address of the prospective member.

3. The method according to claim 1, wherein said determining step comprises determining if the prospective member is eligible for credit.

4. The method according to claim 1, wherein said determining step includes searching said information database to see if the prospective member is already a member of the loyalty or club program.

5. The method according to claim 1, further comprising forwarding a signal to a merchandiser to allow said prospective member to participate only in a normal business transaction if the result of the determining step is no.

6. The method according to claim 1, further comprising providing the prospective member with access to available club member purchase programs if the determining step results in the determination that the prospective member is already a member of the loyalty or club program.

7. The method according to claim 1, wherein said determining step comprises determining whether the prospective member is a current or former club or program member by checking a master file and forwarding a fail signal to a merchandiser if the answer is yes.

8. The method according to claim 7, wherein said determining step further comprises checking whether any club or program member matches to the same name or address.

9. The method according to claim 1, wherein said determining step comprises inquiring whether the prospective member has ever been flagged.

10. The method according to claim 1, wherein said determining step comprises inquiring whether the prospective member has applied for membership within a predetermined time period and forwarding a fail signal to a merchandiser if the answer is yes.

11. The method according to claim 1, wherein said determining step comprises inquiring whether a membership offer has been made to said prospective member within a predetermined time period and forwarding a fail signal to a merchandiser if the answer is yes.

12. The method according to claim 1, wherein said determining step comprises inquiring whether the prospective member has only a post office box address on file and forwarding a fail signal to a merchandiser if the answer is yes.

13. The method according to claim 1, wherein said determining step comprises determining whether the prospective member has a domestic address and forwarding a fail signal to a merchandiser if the answer is no.

14. The method according to claim 1, further comprising forwarding personal information about said prospective member to a credit facilitator and determining a creditworthiness score for said prospective member.

15. The method according to claim 14, further comprising comparing the creditworthiness score to a minimum threshold level and transmitting a signal representative of creditworthiness to said credit facilitator.

16. The method according to claim 15, further comprising said credit facilitator transmitting an approval or a non-approval signal to a merchandiser operating said loyalty or club program.

17. The method according to claim 15, further comprising not extending a credit card offer to said prospective member if the creditworthiness score is below said minimum threshold level.

18. The method of claim 15, further comprising extending an offer to said prospective member to sign up for a credit card affiliated with the loyalty or club program.

19. The method of claim 18, wherein said extending step includes offering incentives to said prospective member to accept said credit card.

20. The method of claim 18, further comprising pooling a plurality of offers which have been accepted by a plurality of prospective members, and transmitting said pooled offers to an organization for generating a letter and a credit card application to each of said prospective members.

21. The method of claim 18, further comprising issuing a credit card affiliated with said club or loyalty program to said prospective member upon enrollment in the club or loyalty program.

22. The method of claim 1, further comprising enrolling said prospective member into said loyalty or club program by creating a loyalty or club program identification number for said prospective member and a credit limit.

23. The method of claim 22, further comprising awarding said prospective member sign-on bonus points upon enrollment and additional points resulting from purchased merchandise.

24. The method of claim 1, further comprising inputting information about a unique customer number for said prospective member, membership fail/pass results, credit bureau processing codes and results, pitch results, pitch start and stop times, customer acceptance of credit card pitch, customer request for mail application, customer decline of credit card, offer letter, and welcome letter mailings into said activity tracking database.

25. The method of claim 24, further comprising providing a merchandiser with information about the success of pitches made to prospective customers.

26. The method of claim 1, further comprising maintaining a database with information about points accrued by club members after enrollment in the club or loyalty program.

27. The method of claim 26, further comprising providing an enrolled member of the club or loyalty program with access to the database with information about accrued points and allowing said enrolled member to redeem points or add points to the account.

28. The method of claim 27, wherein said redemption or addition of points takes place during at least one of an Internet transaction, a mail transaction, a telephone transaction, and a point-of-sale terminal transaction.
